(19) United States
(12) Patent Application Publication
(10) Pub. No.: US 2013/0008895 A1
(43) Pub. Date: Jan. 10, 2013

(54) DOUBLE LINE BREAK

(75) Inventors: John Michael Todd, Louisville, KY (US); Jeremy M. Green, Louisville, KY (US); Patrick D. Galbreath, Louisville, KY (US); Kyle Robert Eden, Louisville, KY (US); Craig Nold, Louisville, KY (US)

(73) Assignee: General Electric Company

(21) Appl. No.: 13/177,282

(22) Filed: Jul. 6, 2011

(51) Int. Cl. H05B 6/68

(52) U.S. Cl. 219/715

(57) ABSTRACT

A system and methods are disclosed for providing a double line break having a secondary power break to function components in a microwave oven. The double line break includes at least two power switches, such as relay devices that provide back-up protection in case one switch fails, or a primary interlock switch corresponding to a door of the oven.

### BACKGROUND

The subject disclosure relates generally to cooking appliances, and more particularly to oven appliances, such as microwave ovens, hybrid ovens and the like.

Magnetron microwave generators are widely used in food preparation appliances, such as microwave ovens and hybrid ovens with both RF radiation heat sources and convection heat sources. The power supply utilized in many presently available microwave ovens utilizes a high-reactance voltage step-up transformer that is often coupled with a voltage doubler. For example, a capacitance may be in series between the transformer secondary winding and the load, and a voltage-doubling diode is across the anode-cathode circuit of the magnetron to provide a voltage-doubled, half-wave current supply for the magnetron. A rectified sine wave portion of operating current is applied to the magnetron at a repetition rate equal to the line frequency, e.g. 60 Hertz (Hz.). These relatively-low-frequency power supplies are of relatively great weight and require additional structural strength in the microwave appliance to protect against physical damage during shipment and use. Additionally, the typical magnetron power supply is costly to manufacture.

In some cases a point of failure may occur in the power circuitry driving the magnetron that causes the oven to continue to operate after the cooking cycle is over. These issues can be the result of a single point of failure, such as a welded relay, and in some cases, the oven will be perceived as active when a door switch has failed. It is desirable to more easily control the amount of energy being supplied to the microwave-power-generating magnetron to provide greater control of the food preparation sequences and provide greater safety.

### BRIEF DESCRIPTION OF THE DISCLOSURE

Systems and methods for microwave safety power switching circuits are disclosed. A microwave oven, in one embodiment, comprises a heated cavity having a cavity wall with an opening exposing the heated cavity to energy for cooking. An RF generator provides energy to the heated cavity and a power circuit is coupled to a motor circuit for electrically driving a plurality of loads wherein the power switching circuit is connected to at least one first AC voltage line and a neutral line for supplying power to the RF generator from an AC power supply. The power switching circuit includes an external printed circuit board having a microprocessor, a first power switch and a secondary power switch that each has a first terminal and a second terminal. The first power switch and the second power switch are operatively connected to one another and are each selectively switchable between first and second operating states to enable an AC current that is provided to the RF generator based on commands from the microprocessor and the operating states of both devices.

Still other features and benefits of the present disclosure will become apparent from reading and understanding the following detailed description.

### BRIEF DESCRIPTION OF THE DRAWINGS

Reference is now made briefly to the accompanying drawings, in which:

FIG. 1 is a front, perspective view of a microwave oven according to one aspect of the present disclosure.

FIG. 2 is a schematic representation of a power switching circuit according to an exemplary embodiment of the present disclosure.

FIG. 3 is a schematic representation of a power switching circuit according to another exemplary embodiment of the present disclosure.

FIG. 4 is a flow diagram illustrating an example methodology for a power switching circuit according to one embodiment of the present disclosure.

Like reference characters designate identical or corresponding components and units throughout the several views, which are not to scale unless otherwise indicated.

### DETAILED DESCRIPTION

Appliances, such as microwave ovens, hybrid microwave and convection ovens utilizing radiation, conventional heat sources, and the like, are implemented with concepts illustrated and detailed herein. Ovens, such as microwave ovens include a power switching circuit that has a secondary powerbreak to an RF generator. This power break is configured along any combination of L1, L2, or N power cord lines to disconnect the lines accordingly for safe operation of the oven. For example, the secondary power break may be provided either before or after a printed circuit board having relay components thereon. Such a secondary power break includes power switches and/or relays that ensure an AC current flow when in a closed configuration together for the oven to function.

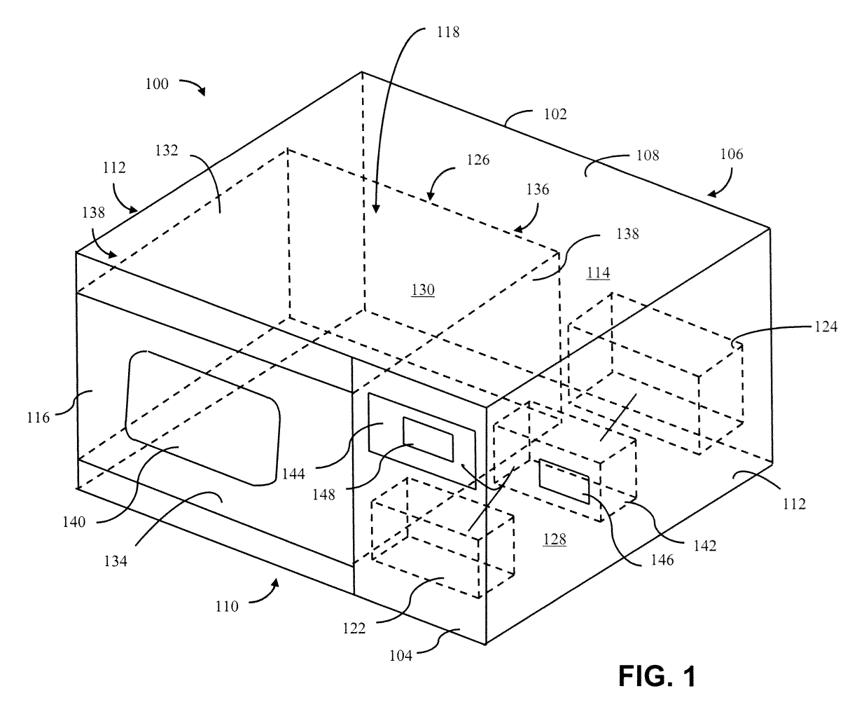

FIG. 1 illustrates an aspect of an exemplary oven 100, such as a microwave or the like. The oven 100 includes an outer housing 102 generally configured to permit placement of the oven 100 on a counter or secured to kitchen cabinetry or a kitchen wall. The outer housing 102 is configured with a front panel 104, a rear wall 106, a top wall 108, a bottom wall 110, and pair of opposed side walls 112. Combined together, the walls of the outer housing 102 form an interior cabinet 114, accessed by way of a door 116 and which surrounds a heated cavity 118 and components 120 such as a power supply 122 and an RF generation module that includes a magnetron 124. Although not illustrated, the oven may include additional or secondary heating sources in combination with the magnetron 124, such as convectional sources for heating items within the heated cavity 118.

The heated cavity 118 also includes a cavity wall 126 that serves to separate the interior cabinet 114 into a component compartment 128 and a cooking compartment 130, the latter provided to subject food to radiation from, e.g., the magnetron 124. The cavity wall 126 in this example includes a top cavity wall 132, a bottom cavity wall 134, a rear cavity wall 136, and a pair of opposed side cavity walls 138. The door 116 is mounted within a door frame (not shown), a grille (not shown) and a window 140 located in the door for viewing food in the oven cooking cavity 126. The oven 100 has a control panel 144 for receiving and operating control instructions for cooking, and further has a controller 142 that is operatively associated with power consuming feature/functions of the oven 100. The controller 142 can include a micro computer on a printed circuit board (PCB), which is programmed to selectively control energizing of the power consuming feature/functions of the oven.

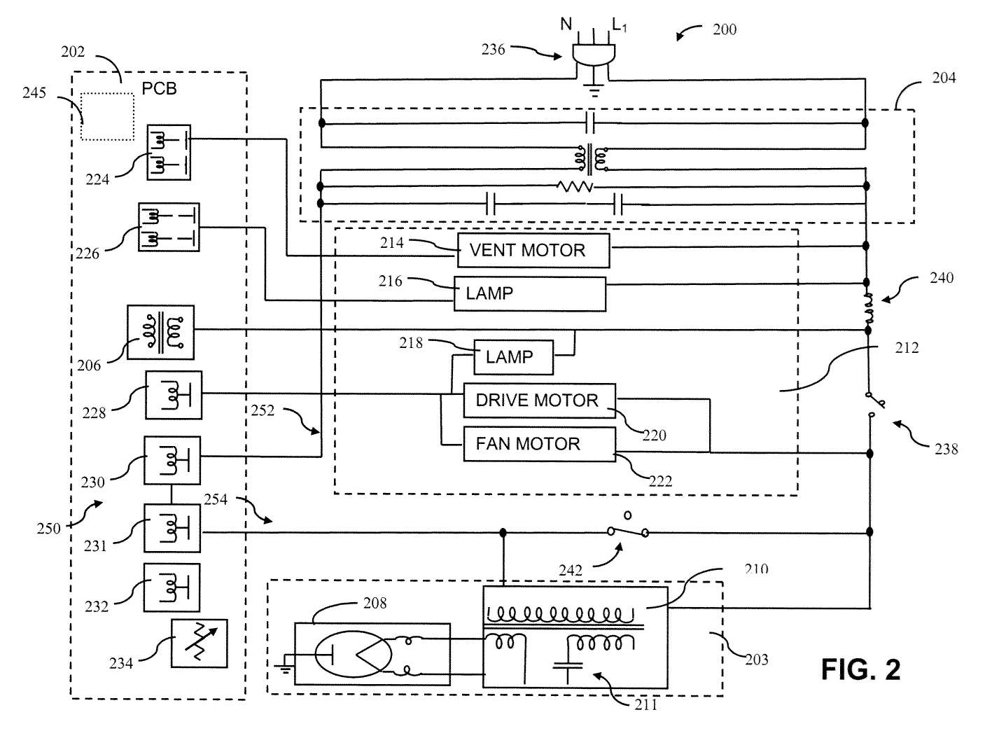

FIG. 2 illustrates aspects of exemplary embodiments of a cooking appliance 200 having a power switching circuit 202 integrated on a PCB for controlling current flow to an RF generator 203. The appliance 200 further includes a motor circuit 212 for driving various loads, such as a vent motor 214 for ventilating items heated by energy within the appliance (e.g., the heated cavity 118 of FIG. 1), and an input filter 204 that receives an input power from an AC power supply 236 and supplies a filtered supply current. The motor circuit 212 further includes a cook-top lamp 216, an oven lamp 218, a drive motor 220, and a fan motor 222. The motor circuit 212 is not limited to these particular loads and may include other electrical loads that are driven for various functions of the oven 200.

The RF generator 203 includes a magnetron 208 that provides energy to heat food or other items placed within a cavity (e.g., the oven cavity 126). The RF generator 203 further includes a high voltage transformer 210 that transforms microwave energy into RF energy for cooking items in the oven. A high voltage capacitor 211, a high voltage diode (not shown) and/or other electrical devices may be coupled to the high voltage transformer 210 for forming filters, checking or discharging currents, and/or cutting abnormal surge voltage, and the like.

The input filter 204 includes capacitors connected in a parallel configuration to a resistor and a mutual inductor component for filtering unwanted noise from at least one voltage line (L1) and a neutral line (N) of the power supply 236. A second voltage line (L2) may also be provided for increasing voltage from 120V to 240V. Other electrical components may also be provided within the input filter 204 and the present disclosure is not limited in scope to any particular noise filter.

The power switching circuit 202 includes various switching devices and at least one DC power supply 206 for controlling the switching devices with a low voltage DC supply. The various switching devices operate to control electrical power to respective loads of the motor circuit 212. For example, a relay 228 controls the cavity or interior lamp 218, the turntable or drive motor 220, and the component cooling fan motor 222. Alternatively each of these components, namely the lamp, the drive motor, and/or the cooling fan may be controlled by their own individual switching device (e.g., a relay, transistor or other switching device), or any combination of these components may be controlled by any combination of switching devices.

The power switching circuit 202 further comprises an inrush relay 232 coupled to a variable resistor 234 that controls inrush current when the RF generator 203 initially powers on. This controls any surges that may result for electrical protection of the power switching circuit 202. The circuit 202 also includes other switching devices and components, which may or may not be illustrated, such as a double poled relay 224 and 226, which control the vent motor 214 and cook-top lamp 216 respectively.

A double line break 250 is also provided by the power switching circuit 202 that comprises a first power switch 231 and a second power switch 230 coupled together in a series configuration. Each of the power switches 230 and 231 includes at least two terminals, a first terminal and a second terminal. For example, a first terminal 252 of the first power device 230 is connected to the neutral line N of the AC power supply 236 and receives the filtered AC supply current from the input filter 204. Further, the second power switch 231 has a first terminal 254 connected to the RF generator 203, while both the power switches are further coupled together in series at their respective second terminal, for example.

The first and second power switches 230 and 231 operate as current controlled switches to the RF generator 203 for power safety together with other switching devices coupled to the RF generator 203. For example, thermal cut-out (TCO) devices 240 open to prevent a filtered AC current along the first voltage line (L1) when a temperature threshold has been reached. In addition, a primary interlock switch 238 is connected in series along the first voltage line (L1) that corresponds to a position of an oven door, such as the oven door 116 of FIG. 1. When the oven door 116, for example, is open, then the switch is opened as illustrated in FIG. 2, and when the oven door is closed, for example, the switch 238 is closed to allow AC current. Other switching devices that operate as door monitoring switches are also provided and coupled to the RF generator 203. For example, a monitor interlock switch 242 operates in conjunction with the door together with the primary interlock switch 238 and/or with other switching devices (not shown). For example, when the door 116 of the oven is closed, the interlock switch 242 is open to allow current to flow to the high voltage transformer 210 of the RF generator 203, if the double line break 250 coupled in series within the neutral line (N) is in a closed configuration.

In one embodiment, the double line break 250 includes power relays that are controlled by a processor or controller 245 on the printed circuit board of the power switching circuit 202. The printed circuit board is external to the motor circuit 212 and the input filter 204 of the oven in order for external monitoring controls to be implemented. For example, the power switching circuit 202 provides a separate low voltage supply 206 to each of the switching devices thereon for their own independent operation separate from the electrical and mechanical controls of the oven connecting the motor circuit 212 and the RF generator 203. Feedback mechanisms (not shown) that are received by the processor 245, for example, trigger the processor to signal the first and second power switch relays 230 and 231. The feedback can be in the form of user operational feedback that signals the microwaves safety for operation or not. The power switch relays 230 and 231 may be closed as a result of a signal provided to the processor, the user pushing a button, or mechanically opening and closing the switches or relays.

Alternative configurations of the double line break are also envisioned. For example, the first power switch 230 may be configured in series with the primary interlock switch 238, or at least one of the first power switch and the second power switch is connected to an additional or second line voltage that provides a 240 voltage supply together with the first voltage line L2. Any configuration of the double line break is envisioned in which at least one or both of the power switches 230 and 231 are connected to the neutral line, the first voltage line L1 and/or a second voltage line L2.

An advantage of having each of the power switches 230 and 231 is that they provide protection against single point failures, which can result when a relay fails or is welded improperly. In this case, the relay remains closed when it fails and allows current to flow to the RF generator at all times. Having not just one power switch, but two power switches 230 and 231 for back-up to one another on a separate external printed circuit board, in addition to the primary interlock switches 238 and monitor switches 242, provides protection against single point failures. Where one of the switches may fail, another provides back-up protection.

In addition, having a double line break 250 for controlling AC current to the RF generator 203 provides protection to the oven from an unexpected, power operation of components perceived as an activation of the oven when a door switch, such as the primary interlock switch 238 is not engaged or has failed. For example, the oven may be perceived as on due to the primary door switch not being engaged or has failed. This could then activate the turntable, cavity lights, and fan with the door closed.

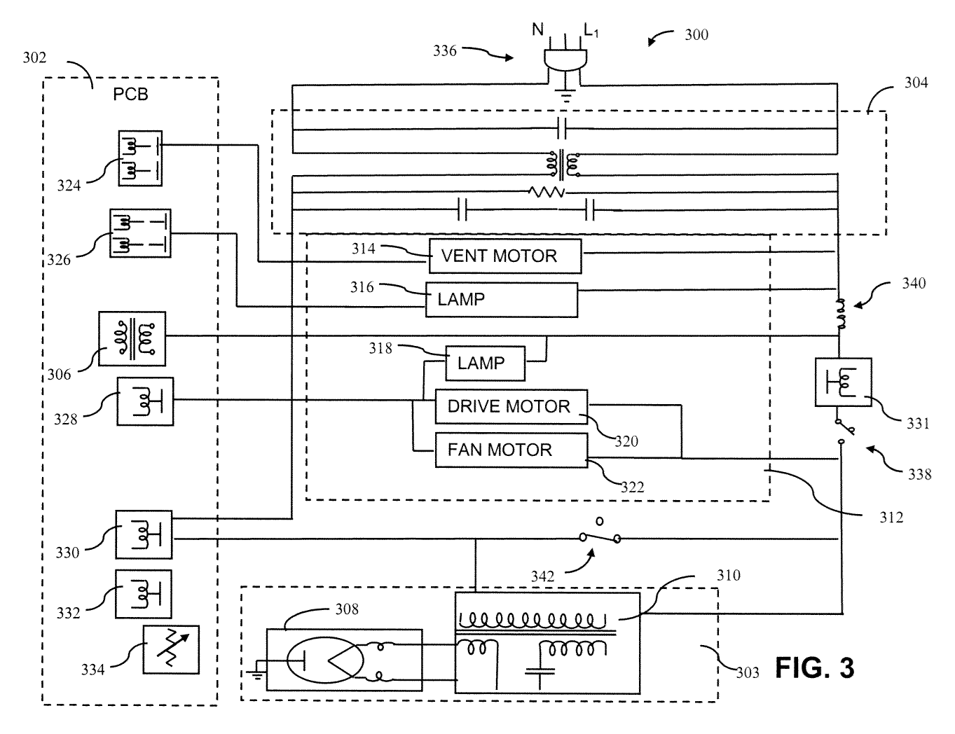

Referring to FIG. 3, illustrated is another aspect of an exemplary embodiment of the disclosure of a microwave oven protection circuit 300 in which an AC power supply 336 provides an AC current to an RF generation device 303. The RF generation device 303 provides energy to a microwave oven and comprises a magnetron 308, a high voltage transformer for converting microwaves to RF waves, and any combination of high voltage diodes, and/or high voltage capacitors thereat. The energy provided cooks items within the oven. A motor drive circuit 312 powers various loads for functions included with the oven. For example, a vent motor 314, a lamp 316, such a cook-top lamp, a lamp 318, a drive motor 320 and a fan motor 322 of the motor circuit 312 each have respective power switches 324, 326, 328 for controlling power thereto located on an external power circuit board. Coupled between the neutral line N and a first voltage line L1 is a monitor interlock switch 342 that operates with a primary interlock switch 338 to prevent power to the microwave based on whether the oven door is in a closed position or not.

An input filter for filtering the AC current from the AC power supply 336 provides a filtered current along the neutral line N and at least one first voltage line. The neutral line N is connected to a first power switching device 330 on a power switching circuit board 302, which is configured as a separate and external board from the motor circuit 312 and the RF generation device 303. A first terminal of the first power switch is connected to the neutral line N, and a second terminal to the monitor interlock switch 342 and a primary winding of the high voltage transformer 310. A second power switch 331 is connected in series to the primary interlock switch 338. When the primary interlock switch 338, the first power switch 330 and/or the second power switch is in an open configuration, AC current is prevented from powering the RF generation device 303. Any number of configured connections between a first voltage line L1, a second voltage line L2, and a neutral line are envisioned with the first power device 330 and the second power device 331. Both can be configured in series to cut AC current along the neutral line on the printed circuit board of the microwave oven power switching circuit 302. The first power switch and the second power switch may further be connected along a second voltage line L2 for powering devices requiring 240V from the power supply 336. In addition, one power switch may be configured to connect on one line and another on an alternative line, such as illustrated in FIG. 3 as one example of the different configured connections.

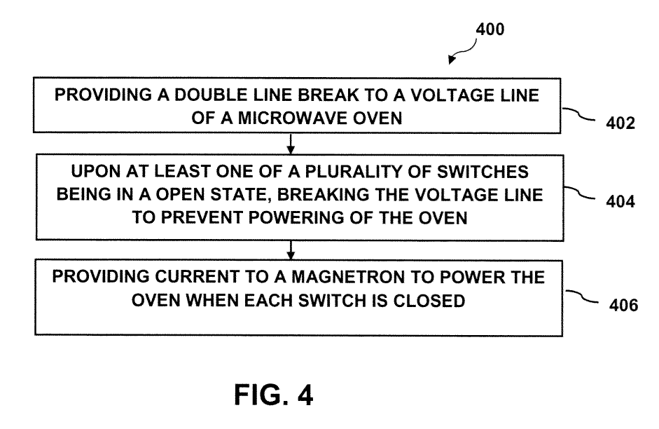

Example methodology 400 for operating an oven having a controller and a memory for executing the method is illustrated in FIG. 4. While the method is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

At 402 the methodology 400 begins with providing a double line break as discussed herein to an AC voltage line to a microwave oven. The double line break includes a plurality of switches including a first power switch and a second power switch. In one embodiment, each of the switches include a relay provided on an external circuit board for controlling AC current to a power generator of the microwave oven.

In one embodiment, a microcontroller provides signals to the plurality of switches. At 404 upon at least one of the plurality of switches being in an open state, the voltage line to the generator of the oven is broken and no longer able to receive the AC current for powering. At 406, current is provided to a magnetron of the RF generator to power the oven when each switch is closed.

In view of the forgoing discussion, while the concepts of a double line break with at least two switching devices have been presented in connection with ovens (e.g., the oven 100), implementation of these concepts can extend to other appliances. Stoves, ranges, ovens, and other devices, which may be outfitted with radiative elements such as magnetrons to facilitate cooking and preparation of food.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A microwave oven, comprising:
a heated cavity having a cavity wall with an opening exposing the heated cavity to energy for cooking an item therein;
an RF generator that provides energy to the heated cavity; and
a power switching circuit coupled to a motor circuit for electrically driving a plurality of loads, wherein the power switching circuit is connected to at least one first AC voltage line and a neutral line for supplying power to the RF generator from an AC power supply;
wherein the power switching circuit includes an external printed circuit board having a microprocessor, a first power switch and a secondary power switch that each has a first terminal and a second terminal, wherein the first power switch and the second power switch are operatively connected to one another and are each selectively switchable between first and second operating states to enable an AC current that is provided to the RF generator based on commands from the microprocessor and the operating states of both devices.

2. The oven of claim 1, further comprising:
an input filter coupled to the motor circuit for receiving an input power via the at least one first voltage line and the neutral line and providing a filtered supply voltage and current to the RF generator, wherein the RF generator includes a magnetron, a high voltage transformer, high voltage capacitor and/or a high voltage diode for generating energy to the heated cavity.

3. The oven of claim 1, wherein the first power switch and the secondary power switch comprise relay switches that are connected in series with one another to provide safety to the oven by breaking the first voltage line to the RF generator when at least one of the switches is open and to provide an AC current to the RF generator when the first power switch and the secondary power switches are closed.

4. The oven of claim 1, wherein the first power switch operates in conjunction with the secondary power switch to cause AC current to be supplied to a primary coil of a high voltage transformer of the RF generator that is operatively connected to the first voltage line and the neutral line when the first and the second secondary power switches are closed.

5. The oven of claim 1, wherein the AC power supply further includes a second voltage line, wherein the second voltage line is disconnected from a primary winding of a high voltage transformer of the RF generator when either the first power switch or the second power switch is open, wherein the first power switch and the secondary switch are coupled in series to a DC power supply for providing an external power control board supply voltage to each switch on the printed circuit board.

6. The appliance of claim 1, wherein the first terminal of the first power switch is connected to a neutral power line and the second terminal of the first power switch is connected to a primary winding of a high voltage transformer of the power circuit.

7. The oven of claim 6, wherein the first terminal of the second power switch is connected to the first voltage line and the second terminal of the second power switch is connected to a primary interlock switch that has an open and closed configuration that corresponds to an open and closed configuration of a door to the heated cavity.

8. The oven of claim 1, wherein the power circuit further comprises a second voltage line that supplies power to the RF generator with the first voltage line and the neutral line.

9. The oven of claim 8, wherein the first power switch and the second power switch are coupled to the second power line and break power to the RF generator when both are in a closed configuration state.

10. The oven of claim 8, wherein the appliance comprises a hybrid oven with a secondary heating source that supplies heat to the cavity from a different source than the RF generator.

11. A microwave oven switching circuit comprising:
a first power switch that is operatively coupled to an RF generator that supplies RF energy into a heated cavity for heating items therein;
a second power switch electrically connected to the RF generator and to at least one AC voltage line, wherein at least one of the first and the second power switch is electrically connected to a DC power supply, wherein each of the first and second power switch is selectively switchable between first and second operating states to control AC power provided to the RF generator by the at least one AC voltage line.

12. The circuit of claim 11, wherein the first power switch and the second power switch are configured in series to one another on an external circuit board having the DC power supply that provides a switch controlling voltage signal that is controlled by a microprocessor located on the external circuit board.

13. The circuit of claim 11, wherein the first power switch and the second power switch comprise a relay switch that enables current flow to the RF generator to power the microwave oven when both switches are in a closed position, wherein the RF generator includes a magnetron, a high voltage transformer, high voltage capacitor and/or a high voltage diode for generating energy to the heated cavity.

14. The circuit of claim 13, wherein the first power switch or the second power switch is coupled to a primary interlock switch corresponding to a position of a door of the oven and breaks power from the AC power line to the RF generator when the primary interlock switch, the first and/or the second power switch is in an open position.

15. The circuit of claim 14, wherein the primary interlock switch, the first and the second power switch connect an AC current to the RF generator when in a closed position, wherein the first and the second power switch are configured in a closed position based on signals received from a microprocessor on a printed circuit board that is separate from the RF generator.

16. The circuit of claim 13, wherein a first terminal of the first power switch is connected to a neutral power line and a second terminal of the first power switch is connected to a primary winding of a high voltage transformer coupled to the RF generator.

17. The circuit of claim 16, wherein the second power switch is connected to the first power switch in series and the second power switch is connected to the neutral power line.

18. The circuit of claim 16, wherein the second power switch is connected to a primary interlock switch that has a position that corresponds to a position of an oven door to allow an AC current from a first active voltage line, wherein the second power switch is connected in series to the first active voltage line at a first terminal and to the primary interlock switch at a second terminal.

19. A method for powering a microwave heating source, comprising:
providing a double line break including a plurality of power relay switches to an AC voltage line of a microwave oven;
upon at least one of the plurality of switches that are electrically coupled together being in an open state, electrically breaking the AC voltage line to open an electrical connection to the microwave heating source; and
providing AC current in the AC voltage line to the heating source when the plurality of electrically connected switches are closed.

20. The method of claim 19, further comprising:
electrically coupling the plurality of switches including a first switch and a second switch to one another in series to prevent power generation from the heating source when the first switch or the second switch is open.

21. The method of claim 19, further comprising:
electrically coupling a first switch of the plurality of switches to a neutral line and a second switch to a voltage supply line at one terminal of the second switch and to a primary interlock switch corresponding to an open or closed state of an oven door; and
preventing power generation from the heating source when the first switch or the second switch is open and providing the AC current when the first switch, the second switch, and the primary interlock switch are in a closed position.
